(19) United States
(12) Patent Application Publication
(10) Pub. No.: US 2007/0120415 A1
(43) Pub. Date: May 31, 2007

(54) Wheel rim assembly

(76) Inventor: Chun-Ming Kang, Tainan (TW)

Correspondence Address: COOPER & DUNHAM, LLP, 1185 AVENUE OF THE AMERICAS, NEW YORK, NY, 10036, US

(21) Appl. No.: 11/287,790

(22) Filed: Nov. 28, 2005

(51) Int. Cl. B60B 7/01

(52) U.S. Cl. 301/37.24; 301/37.43

(57) ABSTRACT

A wheel rim assembly has a wheel rim and cover. The wheel rim has a disk, a rim flange, a join and a mounting ditch. The disk is mounted to a wheel axle and has a periphery. The rim flange is formed on and around the periphery of the disk and has a mounting edge portion. The join is mounted between the disk and the rim flange. The mounting ditch is defined in and around the join. The cover is mounted on the rim flange and has an inside mounting portion and an outside mounting portion. The inside mounting portion is mounted in the mounting ditch. The outside mounting portion is mounted on the mounting edge portion. Accordingly, to mount the inside and outside mounting portion to the mounting ditch and mounting edge portion is convenient to make the cover to be mounted on the wheel rim securely.

### BACKGROUND OF THE INVENTION

1. Field of the Invention

The present invention relates to a wheel rim, and more particularly to a wheel rim assembly that is convenient in assembling.

2. Description of the Related Art

To prevent a wheel rim from rusting and protect a surface of the wheel rim, a cover is attached to and covers the surface of the wheel rim.

With reference to FIG. 7, a conventional wheel rim assembly in according with the prior art comprises a wheel rim (80) and a cover (90).

The wheel rim (80) is attached to a wheel axle of a car and has a disk (81) and a rim flange (82). The disk (81) has a periphery (not numbered). The rim flange (82) is formed around and extends from the periphery and has an inner surface (not numbered) and an outer surface (not numbered). The outer surface of the rim flange (82) has a stairway-like edge portion (821).

The cover (90) has an inner surface (not numbered), an outside edge (not numbered) and an outside mounting portion (91). The inner surface of the cover (90) corresponds to and is adhered to the inner surface of the rim flange (82). The outside mounting portion (91) is formed around the outside edge of the cover (90) and mounted on the stairway-like edge portion (821) of the rim flange (82).

Because the cover (90) is secured to the wheel rim (80) by adhering the cover (90) to the wheel rim (80), the conventional wheel rim assembly has the following problems:

1. High Cost of the production. Besides mounting the outside mounting portion (91) of the cover (80) to the stairway-like edge portion (821) of the rim flange (82), the inner surface of the cover (90) has to be adhered to the inner surface of the rim flange (82) to fasten the cover (90) to the wheel rim (80). Adhering the cover (90) to the rim flange (82) is time-consuming and costly. And the cover (90) and the wheel rim (80) must be formed precisely to make the cover (90) and wheel rim (80) combined tightly and snugly, and this will increase the cost for manufacturing the wheel rim assembly.

2. Easily falling off. The cover (90) is adhered to the rim flange (82), and a binding layer is formed between the cover (90) and the rim flange (82). However, the binding layer is easily deteriorated due to the change of the climate, such that the cover (90) is easily departed from the wheel rim (80) when the car runs at a high speed. With the separateness of the cover (90), loud noise will generate, even that the cover (80) falls off from the wheel rim (80) when the car runs at a high speed.

### SUMMARY OF THE INVENTION

The primary objective of the present invention is to provide a wheel rim assembly to make the cover mount to the wheel rim securely.

The wheel rim assembly in accordance with the present invention comprises a wheel rim and a cover.

The wheel rim is mounted to a wheel axle of a car and has a disk, a rim flange, a join and a mounting ditch. The disk is mounted to the wheel axle and has a periphery. The rim flange is formed around and extends laterally from the periphery of the disk, and has an inner surface and an outer surface. The outer surface of the rim flange has a mounting edge portion. The join is mounted between the disk and the rim flange. The mounting ditch is defined in and around the join.

The cover is mounted on the rim flange and has an inner surface, an inside edge, an outside edge, an inside mounting portion and an outside mounting portion. The inner surface is corresponding to the inner surface of the rim flange. The inside mounting portion is formed on and around the inside edge of the cover, corresponds to and is mounted in the mounting ditch of the wheel rim. The outside mounting portion is formed on and around the outside edge of the cover, extends to and is mounted on the mounting edge portion of the rim flange.

When the inside mounting portion and the outside mounting portion are mounted in the mounting ditch and on the mounting edge portion, respectively, a gap is formed between the inner surface of the cover and the inner surface of the rim flange to generate tension in the cover. The tension in the cover make the inside mounting portion and the outside mounting portion securely combine with the mounting ditch and the mounting edge portion, respectively.

### BRIEF DESCRIPTION OF THE DRAWINGS

FIG. 1 is an exploded cross-sectional side view of an embodiment of a wheel rim assembly in accordance with the present invention;

FIG. 2 is an operational cross-sectional side view of the wheel rim assembly in FIG. 1;

FIG. 3 is a cross-sectional side view of the wheel rim assembly in FIG. 1;

FIG. 4 is a perspective view in partial section of the wheel rim assembly in FIG. 1;

FIG. 5 is a cross-sectional side view of another embodiment of a wheel rim assembly in accordance with the present invention showing that a mounting ditch of the wheel rim assembly has a mounting notch;

FIG. 6 is a cross-sectional side view of a further embodiment of a wheel rim assembly in accordance with the present invention showing that an inside mounting portion of a cover of the wheel rim assembly is bent toward an outer surface of the cover; and

FIG. 7 is a cross-sectional side view of a conventional wheel rim assembly in accordance with the prior art.

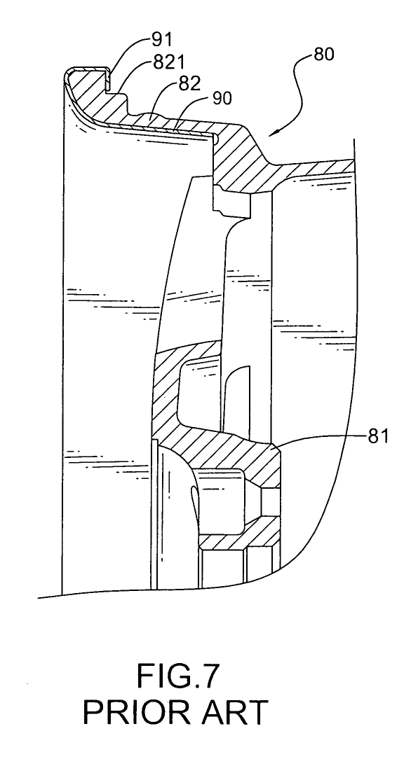

### DETAILED DESCRIPTION OF THE PREFERRED EMBODIMENT

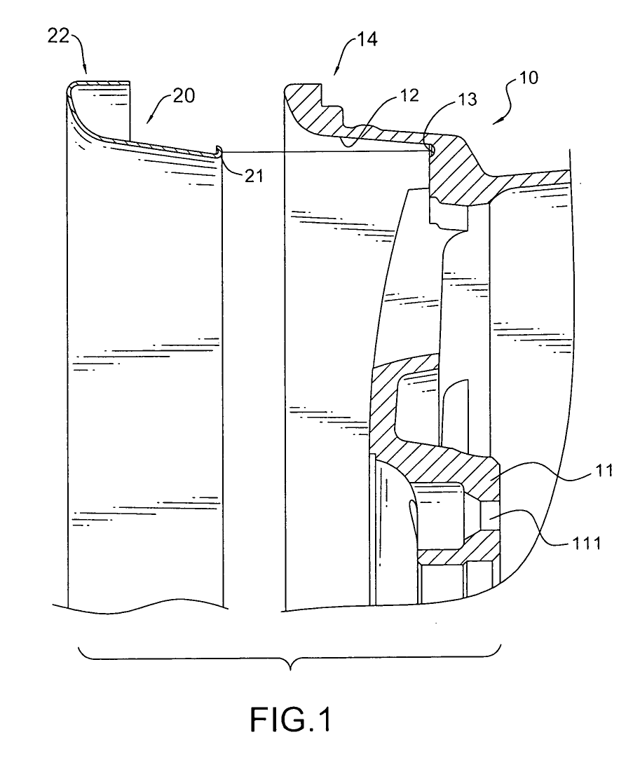

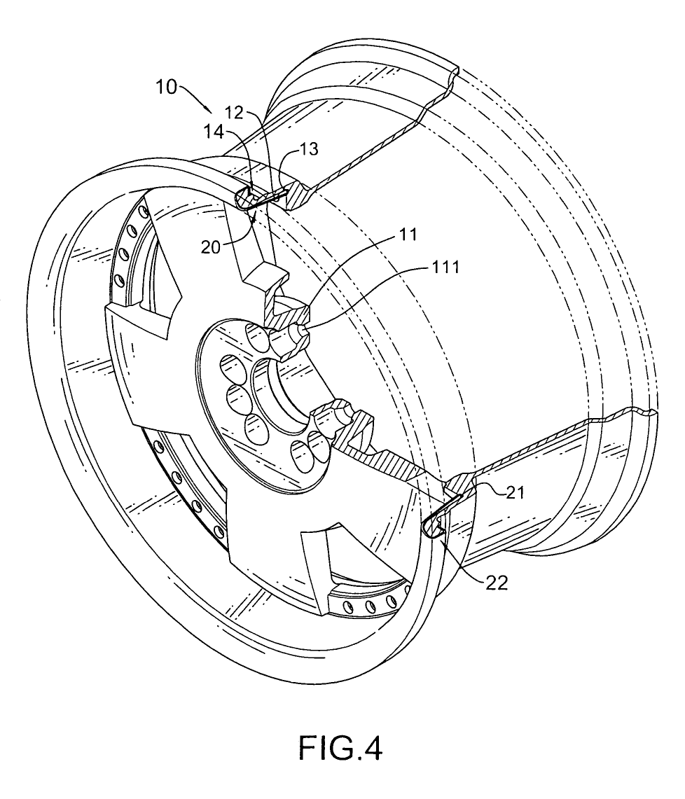

With reference to FIG. 1-4, a preferred embodiment of a wheel rim assembly in according with the present invention comprises a wheel rim (10) and a cover (20).

The wheel rim (10) is mounted to a wheel axle of a car and has a disk (11), a rim flange (12), a join and a mounting ditch (13).

The disk (11) is mounted to the wheel axle and has a periphery, a center, and optional multiple through holes (111). The through holes (111) are defined around the center of the disk (11) to allow bolts extending through to fasten the wheel rim (10) to the wheel axle.

The rim flange (12) is formed around and extends laterally from the periphery, and has an inner surface and an outer surface. The inner surface of the rim flange (12) has a length. The outer surface of the rim flange (12) has a mounting edge portion (14) on which the cover (20) is mounted. The mounting edge portion (14) may be implemented in various shapes. In a first embodiment of the mounting edge portion (14), the mounting edge portion (14) has a stairway-like shape.

The join is mounted between the disk (11) and the rim flange (12).

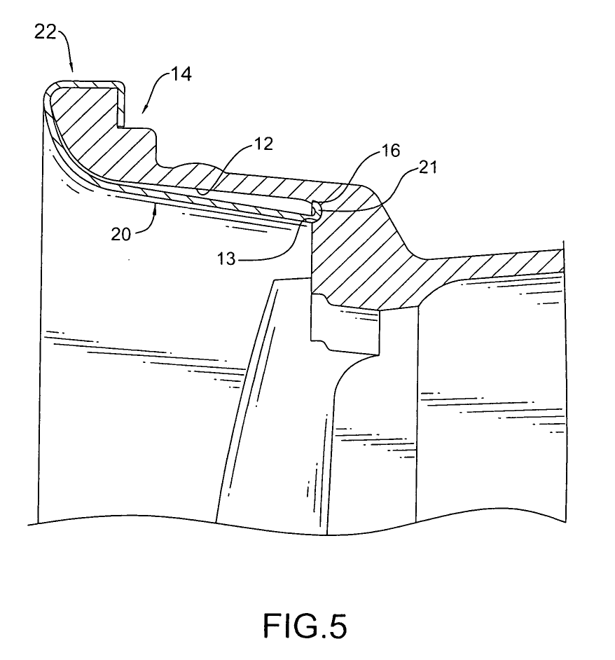

The mounting ditch (13) is defined in and around the join and has a brim. The mounting ditch (13) may further have an optional mounting notch (16). With further reference to FIG. 5, in another embodiment of the wheel rim assembly, the mounting notch (16) is defined in and around the brim of the mounting ditch (13).

The cover (20) is mounted on the rim flange (12) of the wheel rim (10) and has an inner surface, an outer surface, an inside edge, an outside edge, an inside mounting portion (21) and an outside mounting portion (22).

The inner surface of the cover (20) corresponds to the inner surface of the rim flange (12) and has a length. The length of the inner surface of the cover (20) is longer than the length of the inner surface of the rim flange (12).

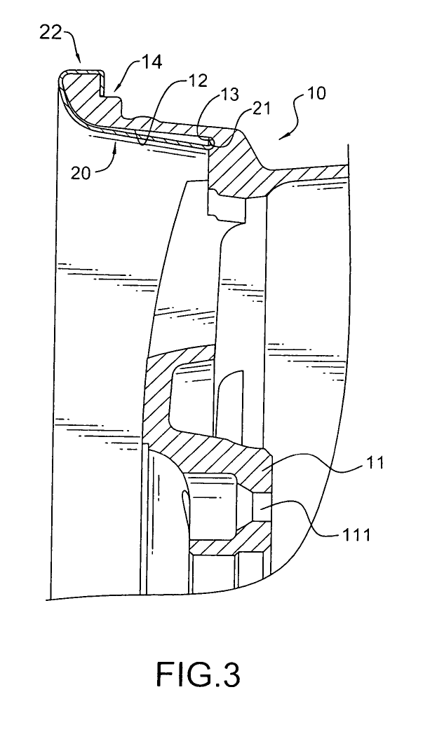

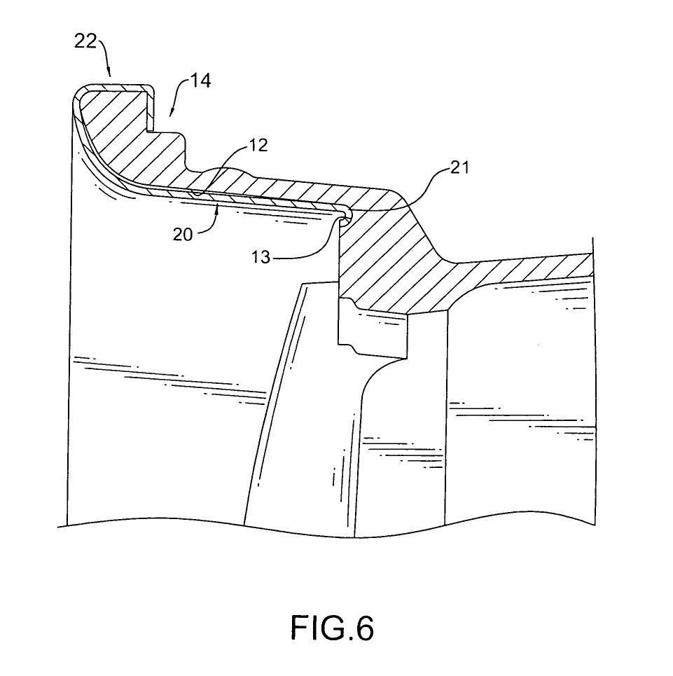

The inside mounting portion (21) is formed on and around the inside edge of the cover (20), corresponds to and is mounted in the mounting ditch (13) of the wheel rim (10) and has a distal end. The inside mounting portion (21) may be implemented in several ways. With further reference to FIG. 3, in a first embodiment of the inside mounting portion (21), the inside mounting portion (21) is U-shaped and bent toward the inner surface of the cover (20). With further reference to FIG. 6, in a second embodiment of the inside mounting portion (21), the inside mounting portion (21) is U-shaped and bent toward the outer surface of the cover (20). With further reference to FIG. 5, in another embodiment of the wheel rim assembly, the distal end of the inside mounting portion (21) is mounted in the mounting notch (16) of the mounting ditch (13).

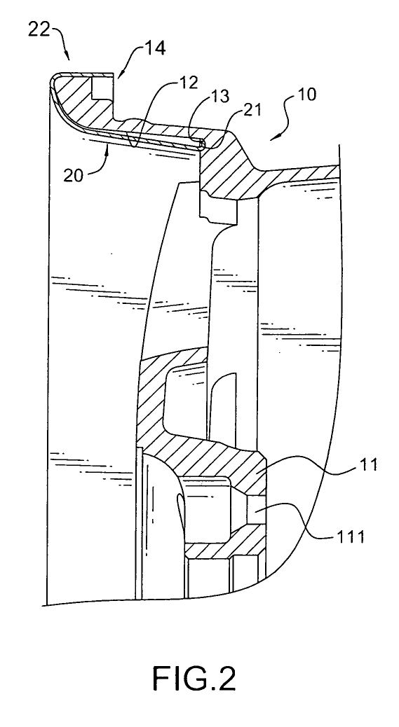

The outside mounting portion (22) is formed on and around the outside edge of the cover (10) and extends to the mounting edge portion (14) of the rim flange (12). With further reference to FIGS. 2 and 3, when mounting the outside mounting portion (22) to the mounting edge portion (14), the outside mounting portion (22) is forced to correspond to and be securely mounted on the mounting edge portion (14).

With further reference to FIGS. 3 and 6, because the length of the inner surface of the cover (20) is longer than the length of the inner surface of the rim flange (12), when the inside mounting portion (21) and the outside mounting portion (22) are mounted in the mounting ditch (13) and on the mounting edge portion (14), respectively, a gap is formed between the inner surface of the cover (20) and the inner surface of the rim flange (12) to generate tension in the cover (20). The tension of the cover (20) make the inside mounting portion (21) and the outside mounting portion (22) abut the mounting ditch (13) and the mounting edge portion (14) more securely.

The wheel rim assembly in according with the present invention has following advantages:

1. Low Cost of Production: Because the cover (20) does not need to contact with the rim flange (12) of the wheel rim (10), the cover (20) and the wheel rim (10) does not need to be formed with high precision. Further, fastening the cover (20) to the wheel rim (10) by mounting is more convenient than adhering. Consequently, the cost for manufacturing the wheel rim assembly is lowered.

2. Enhanced mounting strength: The inside mounting portion (21) and the outside mounting portion (22) are mounted in the mounting ditch (13) and on the mounting edge portion (14), respectively. The tension of the cover (20) makes the inside mounting portion (21) and the outside mounting portion (22) to abut the mounting ditch (13) and the mounting edge portion (14) more securely, respectively. Thus, unintentionally departing the cover (20) from the wheel rim (10) is avoided.

What is claimed is:

1. A wheel rim assembly comprising:
a wheel rim having
a disk having
a periphery; and
a center;
a rim flange formed around and extending laterally from the periphery of the disk and having
an inner surface having a length;
an outer surface having a mounting edge portion;
a join mounted between the disk and the rim flange; and
a mounting ditch defined in and around the join and having a brim; and
a cover mounted on the rim flange and having
an inner surface corresponding to the inner surface of the rim flange and having a length being longer than the length of the inner surface of the rim flange;
an outer surface;
an inside edge;
an outside edge;
an inside mounting portion formed on and around the inside edge of the cover, corresponding to and mounted in the mounting ditch of the wheel rim and having a distal end; and
an outside mounting portion formed on and around the outside edge of the cover, extending to and mounted on the mounting edge portion of the rim flange, wherein a gap is formed between the inner surface of the cover and the inner surface of the rim flange.

2. The wheel rim assembly as claimed in claim 1, wherein the disk further has multiple through holes defined around the center of the disk.

3. The wheel rim assembly as claimed in claim 1, wherein
the mounting ditch further has a mounting notch defined in and around the brim of the mounting ditch; and
the distal end of the inside mounting portion of the cover is mounted in the mounting notch.

4. The wheel rim assembly as claimed in claim 2, wherein
the mounting ditch further has a mounting notch defined in and around the brim of the mounting ditch; and
the distal end of the inside mounting portion of the cover is mounted in the mounting notch.

5. The wheel rim assembly as claimed in claim 1, wherein the inside mounting portion is U-shaped and bent toward the inner surface of the cover.

6. The wheel rim assembly as claimed in claim 2, wherein the inside mounting portion is U-shaped and bent toward the inner surface of the cover.

7. The wheel rim assembly as claimed in claim 3, wherein the inside mounting portion is U-shaped and bent toward the inner surface of the cover.

8. The wheel rim assembly as claimed in claim 4, wherein the inside mounting portion is U-shaped and bent toward the inner surface of the cover.

9. The wheel rim assembly as claimed in claim 1, wherein the inside mounting portion is U-shaped and bent toward the outer surface of the cover.

10. The wheel rim assembly as claimed in claim 2, wherein the inside mounting portion is U-shaped and bent toward the outer surface of the cover.

11. The wheel rim assembly as claimed in claim 3, wherein the inside mounting portion is U-shaped and bent toward the outer surface of the cover.

12. The wheel rim assembly as claimed in claim 4, wherein the inside mounting portion is U-shaped and bent toward the outer surface of the cover.

13. The wheel rim assembly as claimed in claim 1, wherein the mounting edge portion of the rim flange has a stairway-like shape.

14. The wheel rim assembly as claimed in claim 2, wherein the mounting edge portion of the rim flange has a stairway-like shape.

15. The wheel rim assembly as claimed in claim 3, wherein the mounting edge portion of the rim flange has a stairway-like shape.

16. The wheel rim assembly as claimed in claim 4, wherein the mounting edge portion of the rim flange has a stairway-like shape.

17. The wheel rim assembly as claimed in claim 5, wherein the mounting edge portion of the rim flange has a stairway-like shape.

18. The wheel rim assembly as claimed in claim 6, wherein the mounting edge portion of the rim flange has a stairway-like shape.

19. The wheel rim assembly as claimed in claim 9, wherein the mounting edge portion of the rim flange has a stairway-like shape.

20. The wheel rim assembly as claimed in claim 10, wherein the mounting edge portion of the rim flange has a stairway-like shape.
